(19) United States
(12) Patent Application Publication
(10) Pub. No.: US 2004/0248454 A1
(43) Pub. Date: Dec. 9, 2004

(54) Plug connector having a secondary locking system that engages during plug insertion

(76) Inventors: Michael Gunreben, Burgthann (DE); Vincent Regnier, Nurnberg (DE)

Correspondence Address: HARRINGTON & SMITH, LLP, 4 RESEARCH DRIVE, SHELTON, CT, 06484-6212, US

(21) Appl. No.: 10/489,475

(22) PCT Filed: Jun. 2, 2003
(86) PCT No.: PCT/EP03/05760

(30) Foreign Application Priority Data
Jun. 4, 2002 (DE) 102 24 757.9

(51) Int. Cl. H01R 13/627

(52) U.S. Cl. 439/352

(57) ABSTRACT

The invention relates to a plug connector, particularly for airbag activation systems, comprising locking tongues (2), which are oriented in the direction of plugging-in and provided for locking the plug connector (1) inside a mating connector (3), and comprising a secondary locking system (4). This secondary locking system (4) has secondary locking tongues (4a, 4b) that are joined to the plug connector (1) in a fixed manner. When locking tongues (2) engage inside the mating connector (3), said secondary locking tongues elastically spring into the space (5) between locking tongues (2) and the plug connector body (6) while engaging therewith.

The present invention concerns a plug connector according to the preamble of patent claim 1. Such plug connectors principally find application in airbag triggering systems.

The highest requirements are placed on the reliability of such plug connectors and the plug connections produced with them. On the one hand, these requirements involve their reliability over a long period of time and, on the other hand, undefined stress states on the trigger must be avoided in producing the plug connector. For example, it must be assured that, it is abundantly clear to the operator that the plug connector is correctly seated in its final position in the counter-plug, which is conventionally assured by a lock or a catch, and, on the other hand, it must be assured that this final position is not abandoned unintentionally when the vehicle is operated and in particular, during repair operations on the motor vehicle. This is achieved by a secondary lock, i.e., the locking of catch arms in their locked position, so that the plug connection can no longer by disengaged unintentionally.

Known plug connectors for airbag triggering systems, as are known, for example, from DE 125,295 A1 of the patent applicant, use secondary locks which can only be activated if the plug connector is already plugged into the corresponding counter-plug. That is, in the mounted position, the secondary lock is found locked in an intermediate position, from which it is brought into its final position after producing the plug connection with the counter-plug. The plug connector is thus delivered with a secondary lock in an intermediate position, whereby it may happen during delivery or in the handling of the plug connector that the secondary lock is found unintentionally already in its final position, as if the plug connection has been produced, but in this case, connection is prevented. The secondary lock can be disengaged again, but additional time is required and an optional automatically produced installation is made impossible. In addition, after the plug connection has been produced, one may forget to also lock the secondary lock, so that it cannot be excluded with certainty that the plug connection can be disengaged again.

The object of the invention is to extensively improve a plug connector of the given type, so that a secondary locking need no longer be made separately after the connection with a counter-plug has been made, but can be made simultaneously when the plug connector and counter-plug are connected.

This object is solved according to the claim.

Preferred configurations of the plug connector according to the invention are characterized in the subclaims. The principle of the present invention consists of the fact that the radial tilting movement of a locking tab by catching under the corresponding shoulder in the counter-plug is used for controlling the movement of secondary locking tabs, which are prestressed during the process of plugging in, so that when the locking tabs are locked in, the path is made free for the secondary locking tabs to move by their free ends behind the locking tabs in order to make impossible a disengagement of the locking tabs.

The invention will be explained in more detail in the following based on the description of embodiment examples with reference to the drawing, in which the following are shown:

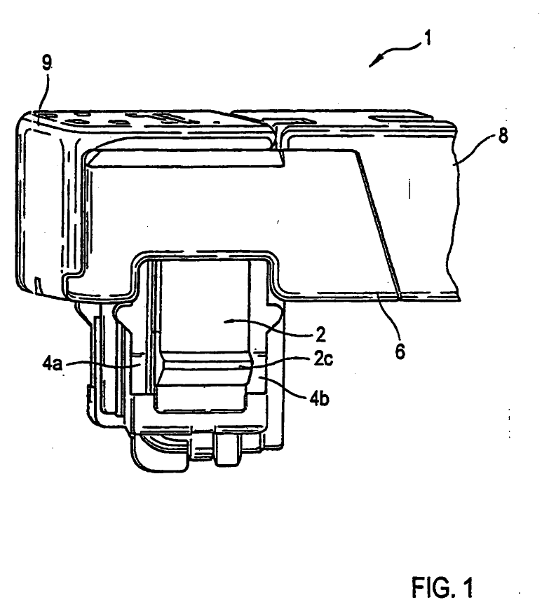

FIG. 1: an embodiment of the plug connector according to the invention in lateral view;

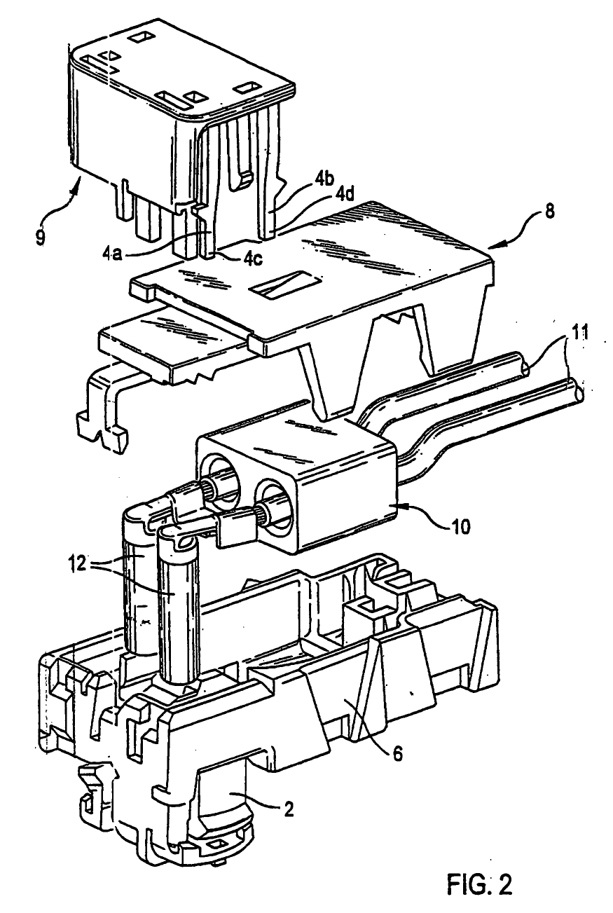

FIG. 2: an exploded representation of the essential components of the plug connector according to FIG. 1;

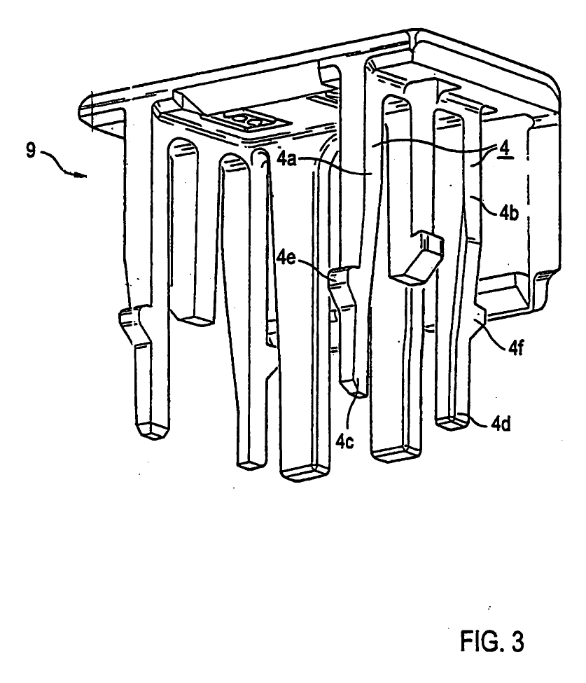

FIG. 3: the clamping piece 9 with secondary locking tabs formed thereon;

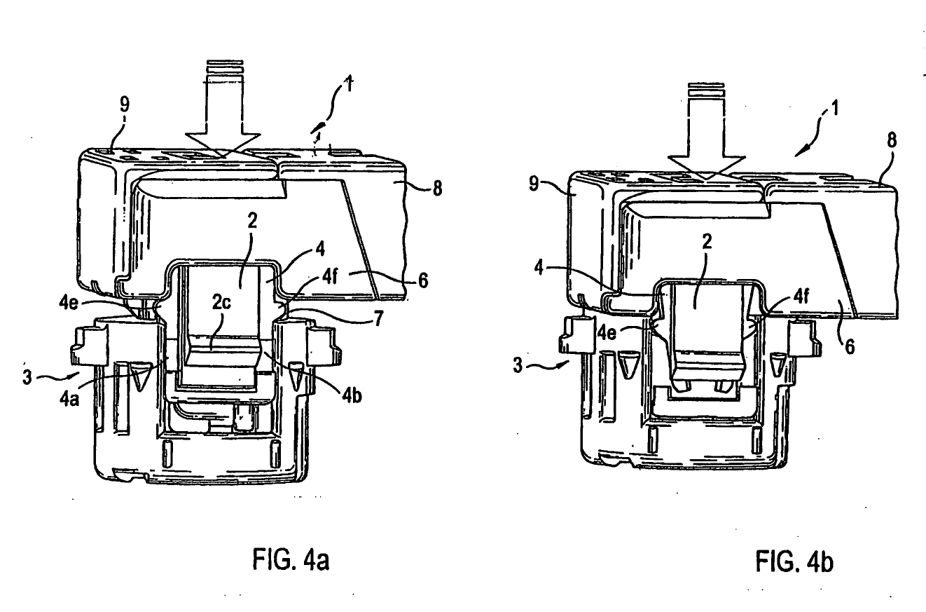

FIGS. 4a, 4b: the plugging-in process of the plug connector according to FIG. 1 into a counter-plug, partially cut away;

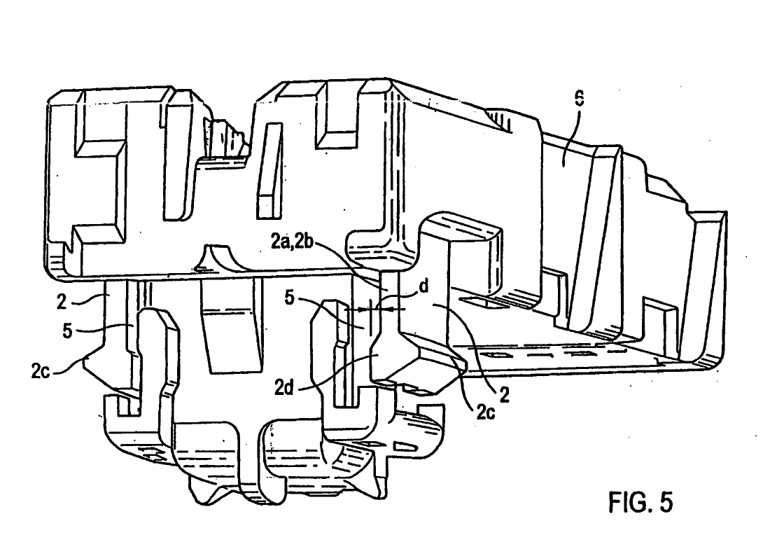

FIG. 5: the plug connector body with locking tabs;

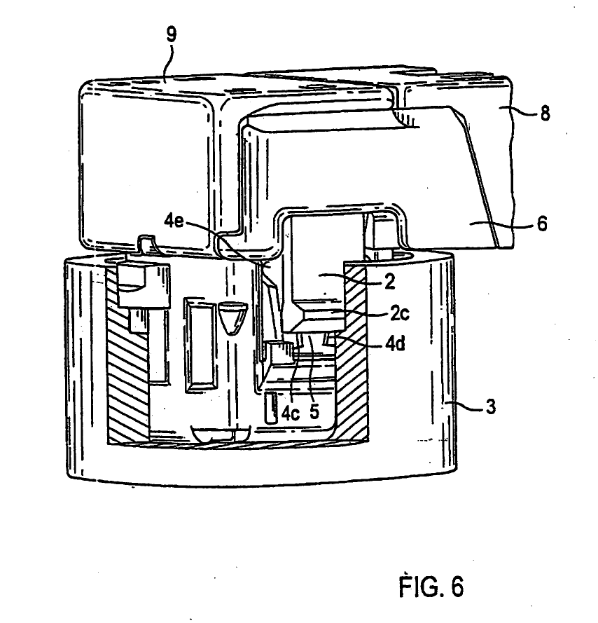

FIG. 6: the plug connector according to FIG. 1 in the state locked in the counter-plug;

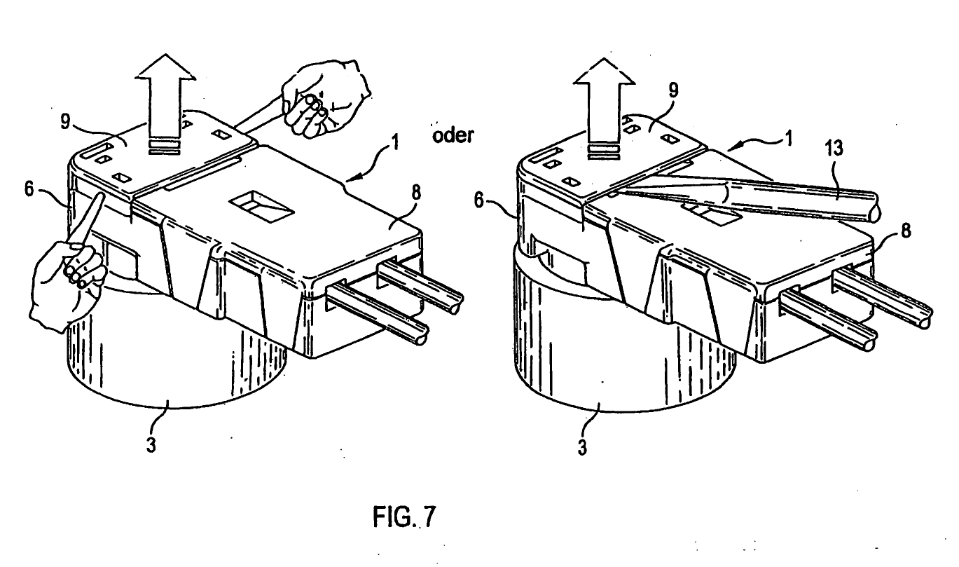

FIG. 7: the disengagement of clamping piece 9 from the plug connector; and

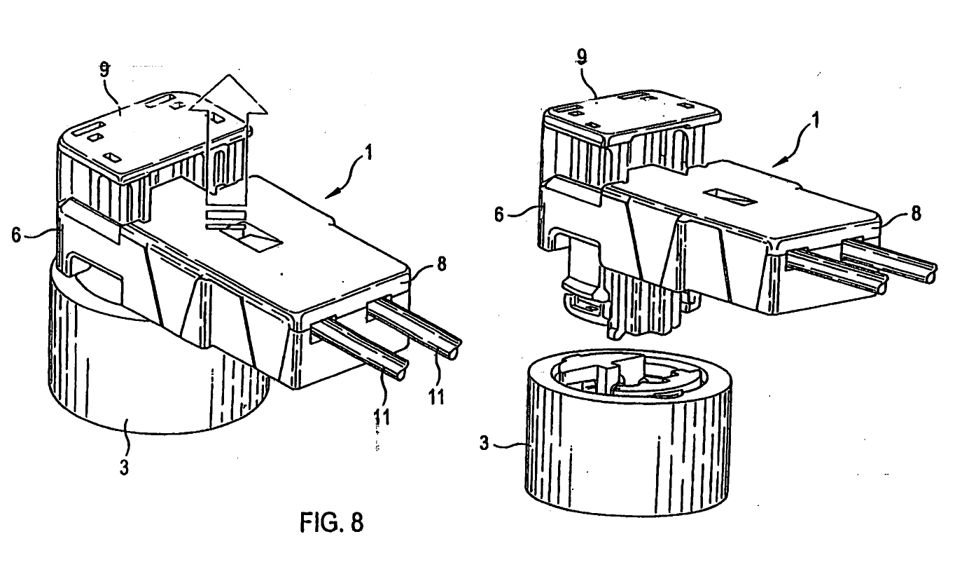

FIG. 8: the disengagement of plug connector 1 from the counter-plug 3 after disengaging the clamping piece 9.

### FIG. 1 shows the plug connector 1 according to the invention with a housing, which essentially comprises the plug connector body 6, the cover 8, and the clamping piece 9.

The plug part extends at a right angle from the flatly constructed housing. The plug part has locking tabs 2 for locking the plug connector 1 in a counter-plug 3. From clamping piece 9, which is fastened to the plug connector body 6 by locking or catching, secondary locking tabs 4a, 4b project in the plugging-in direction on both sides of locking tabs 2.

FIG. 2 shows the essential components of the plug connector according to the invention in an exploded representation. From bottom to top, the plug connector comprises the plug connector body 6, on the plug part of which are formed the locking tabs 2. The cables 11, which are guided through a ferrite core 10 and crimped with plug connector sleeves 12, are inserted into plug body 6. The plug connector is closed off by a cover 8, onto which is plugged the clamping piece 9 above the plug part. The fastening of all housing parts with one another is made each time by a locking or catching.

FIG. 3 shows the clamping piece 9 in perspective view. In addition to the locking tabs, which are not shown in more detail here, for locking or catching the clamping piece to the plug connector body 6, one recognizes 2 pairs of secondary locking tabs 4a, 4b, on whose sides turned away from one another are formed wedge-shaped projections 4e, 4f. It is further recognized that the profile of the secondary locking tabs 4a, 4b taper into free ends 4c, 4d.

FIGS. 4a and 4b show the plugging-in process of plug connector 1 into a counter-plug 3. Only one inlet is shown of counter-plug 3, which is cut open in the region of the locking tabs 2, in order to show the plug part of the plug connector 1. FIG. 4a shows the plug connector 1, which is plugged into counter-plug 3 far enough that the wedge-shaped projections 4e, 4f are applied onto the upper edge of a guide slot 7 in the counter-plug 3. In this position, a catch piece 2c at the same time strikes against a catching shoulder (which is not shown in this illustration) on counter-plug 3, so that when plug connector 1 is pressed further into counter-plug 3, as shown in FIG. 4b, the locking tabs 2 bend when they project over the shoulder in the direction of the plug-in axis.

This bending of locking tabs 2 leads to the circumstance that projection 2d (see FIG. 5) is moved in the direction of the plug-in axis and thus offers the free ends 4c, 4d of the secondary locking tabs 4a, 4b a bearing surface. When plug connector 1 is pushed in further, the central regions of secondary locking tabs 4a, 4b bend due to the contact of wedge-shaped projections 4e, 4f with the narrow sides of the guide slot 7 to such an extent that these central regions bend into a space 5 between the locking tabs 2 and the plug connector body 6.

In the locked state, i.e., plug connector 1 is completely plugged into counter-plug 3, the locking tabs 2 spring back again into their initial position, after they have projected over the (not shown) catching shoulder in counter-plug 3. Simultaneously, they again release the space 5 in the region of the free ends 4c, 4d of the secondary locking tabs 4a, 4b and thus a bearing surface is not longer offered, so that, due to the elastic bending of the secondary locking tabs 4a, 4b they spring behind the locking tabs 2 into space 5, as this is shown in FIG. 4b. The secondary locking is produced in this way, since the locking tabs 2 can no longer move from their locked position in the direction of the plug-in axis.

FIG. 5 shows the plug connector body 6 alone, wherein one can clearly recognize space 5 between plug connector body 6 and locking tabs 2. One can further recognize the configuration of catch piece 2c on locking tabs 2 and the projection 2d on the opposite-lying side, whose width d, which is also shown, corresponds to the amount by which the profile of the secondary locking tabs shown in FIG. 3 taper into their free ends 4c, 4d in this region.

FIG. 6 shows once more a partially cut-open view of the plug connector 1 after locking in the counter-plug 3. It can again be clearly recognized that the free ends 4c, 4d of the secondary locking tabs 4 block a swinging back of locking tabs 2 into the free space 5.

FIG. 7 shows 2 alternative possibilities of how one can disengage clamping piece 9 from plug connector 1. This is done either, as can be seen on the left, by grasping under the lateral edges of clamping piece 9 with the fingernails or fingers or with the help of a tool, for example, a flat screwdriver 13 or the like, which one inserts into a depression provided therefor, with which the tip of the screwdriver is guided under the cover of clamping piece 9. Then clamping piece 9 is pushed up, as is shown in FIG. 8, to such an extent that the secondary locking tabs are raised up enough that they no longer block a tilting of the free ends 2c of locking tabs 2 relative to the plug-in axis. In this position, as is shown in FIG. 8 on the right, the plug connector 1 can be removed from the counter-plug 3.

The preceding description of an example of embodiment of the present invention is not to be understood as limiting, but serves only for illustration of the invention defined in the claims.

1. A plug connector, in particular for airbag triggering systems, with locking tabs (2) arranged in the plugging-in direction, for locking or catching of plug connector (1) in a counter-plug (3) and with a secondary lock (4),
is hereby characterized in that
the secondary lock (4) has secondary locking tabs (4a, 4b), which are rigidly joined with the plug connector (1) and when locking tabs (2) are locked in counter-plug (3), these secondary tabs spring elastically into space (5) between the locking tabs and the plug connector body (6) and thus lock these.

2. The plug connector according to claim 1,
further characterized in that
the secondary locking tabs (4a, 4b) run parallel to both sides of the locking tabs (2), and their free ends (4c, 4d) press elastically at their side edges (2a, 2b) as long as the locking tabs (2) are bent toward the plug-in axis during the locking process, whereby the pressing pressure is produced by wedge-shaped projections (4e, 4f), which are arranged on their outer sides and which are supported on counter-plug (3), and which, as soon as the locking tabs (2) are locked in counter-plug (3), spring by their free ends (4c, 4d) into the space between the plug connector body (6) and the locking tabs (2) and lock the locking tabs (2) in the locked position.

3. The plug connector according to claim 2,
further characterized in that
the locking tabs (2) have at their free ends a catch piece (2c) for locking in counter-plug (3) on the side lying radially outside of the plug-in axis and a projection (2d) on the side lying opposite, on which the free ends (4c, 4d) of the secondary locking tabs (4a, 4b) press during the locking process.

4. The plug connector according to claim 3,
further characterized in that
when the plug connector (1) is introduced into the counter-plug (3), the wedge-shaped projections (4e, 4f) are supported on the narrow sides of introduction slots (7) for locking tabs (2) and the secondary locking tabs (4) and thus the secondary locking tabs (4a, 4b) in their central region are elastically bent into intermediate space (5) between the locking tabs (2) and the plug connector body (6), and the free ends (4c, 4d) of the secondary locking tabs (4a, 4b) press against the projections (2d).

5. The plug connector according to claim 4,
further characterized in that
the introduction slots (7) are dimensioned such that after the locking tabs (2) are locked in counter-plug (3), the free ends of the secondary locking tabs (4c, 4d) are arrested by the support of wedge-shaped projections (4e, 4f) on the narrow sides of the introduction slots (7) in their locking position.

6. The plug connector according to claim 1,
further characterized in that
the secondary locking tabs (4a, 4b) are tapered in their radial width relative to the free ends (4c, 4d) by the width d of projection (2d) at the free end of the locking tabs (2).

7. The plug connector according to claim 1,
further characterized in that
the secondary locking tabs (4a, 4b) are shaped on a clamping piece (9) that can be locked in a detachable manner on the housing (6, 8) of the plug connector (1).

8. The plug connector according to claim 4,
further characterized in that
the wedge-shaped projections (4e, 4f) come to be supported on the narrow sides of the introduction slots (7), if the catch piece (2c) of the locking tabs (2) is supported on a corresponding catching shoulder of the counter-plug (3).
